(19) United States
(12) Patent Application Publication
(10) Pub. No.: US 2013/0244913 A1
(43) Pub. Date: Sep. 19, 2013

(54) COMPOSITION AND METHOD OF CONVERTING A FLUID FROM OIL EXTERNAL TO WATER EXTERNAL FOR CLEANING A WELLBORE

(71) Applicants: L. Jack Maberry, Katy, TX (US); Fati Malekahmadi, Houston, TX (US); David N. Harry, Katy, TX (US)

(72) Inventors: L. Jack Maberry, Katy, TX (US); Fati Malekahmadi, Houston, TX (US); David N. Harry, Katy, TX (US)

(21) Appl. No.: 13/418,778

(22) Filed: Mar. 13, 2012

(51) Int. Cl. C09K 8/52; C09K 8/584

(52) U.S. Cl. 507/261

(57) ABSTRACT

An environmentally acceptable water-in-oil microemulsion composition includes at least one emulsifying surfactant, at least one biodegradable hydrocarbon solvent, at least one co-solvent, at least one hydrocarbon co-surfactant, and water. The microemulsion composition may be used in a method for rendering fluids from oil external to water external. The microemulsion composition may be combined with water or a water based fluid to produce a spacer fluid utilized in removing oil and oil-residues from a surface, particularly that of wellbores in the drilling of oil and gas wells.

### BACKGROUND OF THE INVENTION

1. Field of the Invention

The present invention relates to the composition and use of an environmentally acceptable water-in-oil microemulsion as a spacer fluid to remove oil, oil-based compounds, and oil-residues from a surface such as a wellbore or pipe.

2. Description of the Related Art

During the drilling and completing of oil and gas wells, drilling fluids (also referred to as “muds”) are often utilized. They are used to prevent formation fluids from entering into the well bore, keeping the drill bit cool and clean during drilling, carrying out drill cuttings, and suspending the drill cuttings while drilling is paused and when the drilling assembly is brought in and out of the hole. The drilling fluid used for a particular job is selected to avoid formation damage and to limit corrosion.

Two types of drilling fluids that are commonly used are oil-based mud and synthetic-based mud. Oil-based mud can be a mud where the base fluid is a petroleum product such as diesel fuel. Oil-based muds are used for many reasons, some being increased lubricity, enhanced shale inhibition, and greater cleaning abilities with less viscosity. Oil-based muds also withstand greater heat without breaking down. The use of oil-based muds has special considerations. These include cost and environmental considerations.

Synthetic-based fluid (SBM) (Otherwise known as Low Toxicity Oil Based Mud or LTOBM) is a mud where the base fluid is a synthetic oil. This is most often used on offshore rigs because it has the properties of an oil-based mud, but the toxicity of the fluid fumes are much less than an oil-based fluid. This is important when workers with the fluid are in an enclosed space such as an offshore drilling rig.

Upon the completion of drilling oil and gas wells and during the workover operations, it is necessary to remove the residual oil from wellbore surfaces to prepare them for contact with water-based products.

Removing oil-based drilling fluid residue is necessary to allow cement to bond between casing and formation. Using a spacer fluid, (a liquid used to physically separate one special-purpose liquid from another) to remove oil residue is required to create a good cement bond. Typically mixtures of several different components consisting of solvent and surfactant combinations are used for an effective displacement of oil-based fluid to cement the well.

Microemulsions are clear, thermodynamically stable, isotropic liquid mixtures of oil, water and surfactant, frequently in combination with a co-surfactant. The aqueous phase may contain salt(s) and/or other ingredients, and the “oil” may actually be a complex mixture of different hydrocarbons and olefins. Unlike typical emulsions, microemulsions form upon simple mixing of the components and do not require the high shear conditions generally used in the formation of ordinary emulsions.

Microemulsions are generally classified as 4 types:

Winsor I—the surfactant is preferentially soluble in water and oil-in-water (o/w) microemulsions form. The surfactant-rich water phase coexists with the oil phase where surfactant is only present as monomers at small concentration.

Winsor II: the surfactant is mainly in the oil phase and water-in-oil (w/o) microemulsions form. The surfactant-rich oil phase coexists with the surfactant-poor aqueous phase.

Winsor III—a three-phase system where a surfactant-rich middle-phase coexists with both excess water and oil surfactant-poor phases.

Winsor IV a single-phase (isotropic) micellar solution, that forms upon addition of a sufficient quantity of amphiphile.

Surfactants are compounds that lower the surface tension of a liquid, the interfacial tension between two liquids, or that between a liquid and a solid.

Microemulsions have application in a variety of industrial and chemical industries, for example as detergents, degreasers, cleaners, pharmaceutical and cosmetic preparations. They are also used in the oil and gas industry, for example in enhanced oil recovery and wellbore cleaning and degreasing.

Since microemulsions are comprised of one or more hydrocarbon solvents, co-solvents, surfactants, and water to form a continuous phase translucent composition, microemulsions often dissociate upon mixing with additional water to facilitate cleaning They may also leave a hydrocarbon residue, albeit a less substantial residue than if no microemulsion cleaning agent were used at all, and are flammable due to the presence of low molecular weight alcohols, low molecular weight esters, or aromatic solvents, or are hazardous chemicals because of the chemical nature of the chemical components that comprise them. Some microemulsions are substantially alkaline or acidic, making them corrosive to living tissue.

Accordingly, there is need for a microemulsion cleaning composition that is environmentally acceptable, for example, free of BETX (benzene, ethylbenzene, toluene, xylene) and other hazardous aromatic solvents, non-flammable, and substantially pH neutral.

### SUMMARY OF THE INVENTION

In accordance with the present invention, an environmentally acceptable, reduced-flamability, alcohol-free microemulsion chemistry is provided for removing oil or synthetic-based mud from hard surfaces in the course of a cleaning operation. The inventive microemulsion is suitable for use in pipelines to displace crude oil and refined hydrocarbons, and in well completions or workover operations for the removal of oily residues from equipment, pipe, or formation rock surfaces. Moreover, combining the microemulsion with water or a water based fluid produces a translucent spacer fluid suitable to displace crude oil and refined hydrocarbons or for well completion operations. Thus, the reduced particle size of the microemulsion allows for more effective mud removal than might be obtained with a macroemulsion, defined as an opaque liquid comprising oil, water, and an emulsifying surfactant. The inventive microemulsion chemistry provides a stable dispersion in water. The components of the microemulsion include hydrocarbon solvent(s), co-solvent(s), water, and surfactants.

The present invention discloses new methodologies for combining ingredients to produce a microemulsion that creates a water-wet surface that is equal to or superior to those cleaned with microemulsions comprising aromatic solvents and/or flammable alcohols.

It is therefore an object of the present invention to effectively remove oil or synthetic-based mud from hard surfaces.

It is a further object of the present invention to clean said hard surfaces with a microemulsion that is not harmful to human tissue.

It is still a further object of the present invention to clean said hard surfaces with a microemulsion that does not harm the environment.

It is still a further object of the present invention to clean said hard surfaces with a microemulsion that possesses a high flash point.

Still other objects, features, and advantages of the present invention will become evident to those of ordinary skill in the art in light of the following.

### BRIEF DESCRIPTION OF THE DRAWINGS

FIG. 1 is a picture illustrating the effects of aqueous dilution on the microemulsion additive concentrate.

FIG. 2 is a graph illustrating a mud removal plot.

FIG. 3 is a picture illustrating the mud removal efficiency of increasing aqueous concentrations of the microemulsion.

### DETAILED DESCRIPTION OF THE PREFERRED EMBODIMENT

The present invention provides a new microemulsion and method of use for removing oil or synthetic-based mud from hard surfaces in the course of a cleaning operation.

The microemulsion composition may include one or more hydrocarbon solvents. These solvents are biodegradable, have relatively high flash points (>150° F. PMCC) and may be derivatives of coconut oil, canola oil, corn oil and soybean oil. Examples include, but are not limited to methyl caprylate, methyl caprate, methyl laurate, methyl myristate, methyl palmitate, methyl oleate, canola methyl ester, soya methyl ester, ethyl lactate and various blends and mixtures thereof. The preferred solvent is methyl caprylate/caprate. The solvent portion may comprise from 0 to 70% by weight of the formulation.

The microemulsion composition may include one or more co-solvents. Examples include, but are not limited to alcohols, glycol ethers and mutual solvents. The preferred cosolvent is a specialty alkoxylated solvents marketed by Clariant as a replacement for typical mutual solvent chemistries such as 2-butoxyethanol (BGE, EGMBE, butyl cellosolve). This chemistry does not have the toxicity and handling issues experienced with 2-butoxyethanol chemistries. The cosolvent is commercially available as Clariant Surftreat 9294. The co-solvent portion may comprise from 0 to 70% by weight of the formulation.

The microemulsion composition may include one or more emulsifying surfactants. Examples include, but are not limited to polyoxyethylene sorbitan (20) monooleate, polyoxyetheylene sorbitan (20) monolaurate and also surfactants with lower HLB values. The emulsifying surfactant portion may comprise from 0 to 40% by weight of the formulation.

The microemulsion composition may include one or more hydrocarbon co-surfactants. Examples include, but are not limited to one or more cationic, anionic, amphoteric or nonionic surfactants. The co-surfactant portion may comprise from 0 to 60% by weight of the formulation.

The microemulsion composition may include water. Examples include, but are not limited to fresh water, salt water or brine. The water portion may comprise from 0 to 60% by weight of the formulation and may also include other additives that are soluble, partially soluble or dispersed and may also include an antifreeze agent. Commercially available surfactants and co-surfactants often contain water.

The microemulsion concentrate in Example 1 was prepared by adding the cosolvent to the solvent followed by the addition of the emulsifier. The blending was carried out in a suitable beaker or glass jar with agitation provided by an impellar mixer with sufficient agitation to achieve a slight vortex. The surfactant was added, followed by additional water and the cosurfactant. Approximately one minute was allowed between the addition of each component.

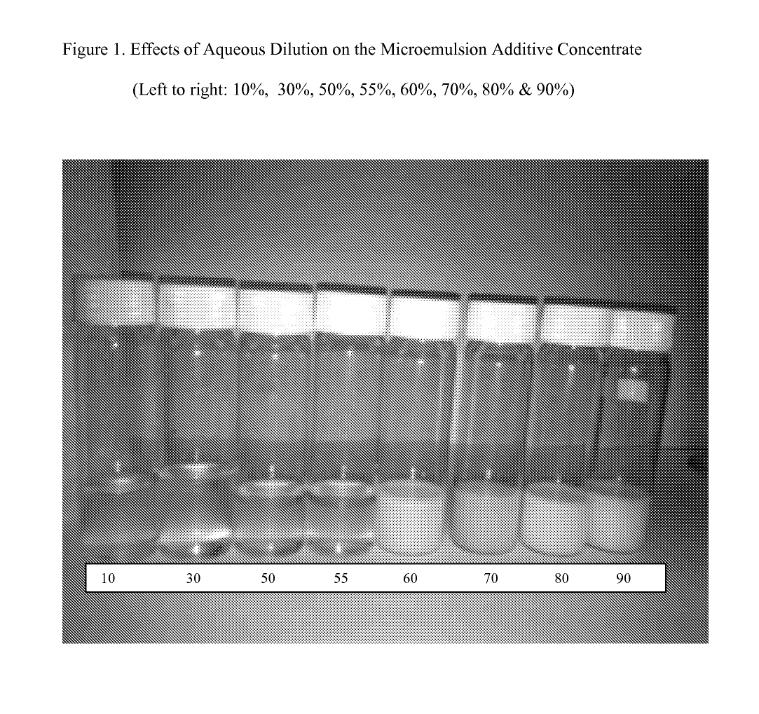

After formulation of the microemulsion, the addition of water or a water based fluid such as salt water or brine affects the properties of the microemulsion and transitions the microemulsion to a spacer fluid according to a preferred embodiment. Table 1 and FIG. 1 illustrate the effects of aqueous dilution through the addition of water or a water based fluid to the microemulsion concentrate. As shown in Table 1 and FIG. 1, the microemulsion of Example 1 produces a translucent composition and retains its microemulsion properties with the addition of up to at least 9% by weight water or water based fluid. With additional water or water based fluid between 9% and 10%, the particle size of the mixture is in a transition phase, moving away from a single phase fluid. Water concentrations between 10% and 55% are no longer single phase microemulsions and some solvent separation is observed, however, the mixture is rapidly re-dispersed with gentle agitation. As water concentrations continue to increase above 55%, and by 60% and above, the mixture changes dramatically, with the appearance of a milky white suspension that shows a tendency to foam and provides a stable dispersion suitable for use as a spacer fluid according to the preferred embodiment. These are likely smaller agglomerations of the microemulsion concentrate, representing oil external phase micelles. The oil external nature of these micellular agglomerations results in the milky white suspension and improved dispersion in the predominant water phase.

TABLE 1
Effects of Aqueous Dilution on the Microemulsion
Additive Concentrate of Example 1

| Microemulsion | | |
|---|---|---|
| Additive | Water | |
| Concentrate | % by | |
| % by weight | weight | Description |
| 100 | 0 | clear, translucent, single phase |
| 91 | 9 | clear, translucent, single phase |
| 90 | 10 | clear, but slightly hazy, single phase |
| 70 | 30 | hazy, some solvent separation |
| 50 | 50 | hazy, some solvent separation |
| 45 | 55 | hazy, some solvent separation |
| 40 | 60 | milky white suspension with some foaming |
| 30 | 70 | milky white suspension with some foaming |
| 20 | 80 | milky white suspension with some foaming |
| 10 | 90 | milky white suspension with some foaming |
| 5 | 95 | milky white suspension with some foaming |

With all components considered, a preferred composition is provided in Example 1.

### EXAMPLE 1

### Microemulsion Composition

| Component | Function | Grams | wt % |
|---|---|---|---|
| Methyl Caprylate/Caprate | Solvent | 16 | 47.62 |
| Clariant Surftreat 9294, CAS | Cosolvent | 8 | 23.81 |
| proprietary | | | |
| Sorbitan monoleate ethoxylate, | Emulsifier | 0.6 | 1.79 |
| polyoxyethylene 20 | | | |
| 26% aqueous solution Sodium | Surfactant | | |
| Lauryl Sulfate (SLS) - | | | |
| Water from aqueous SLS solution | | 4.44 | 13.21 |
| SLS from 26% aqueous solution | | 1.56 | 4.64 |
| Linear alcohol ethyoxylate - | Cosurfactant | 2 | 5.95 |
| DI/RO Water | Water | 1 | 2.98 |
| Total water in formulation | | 5.44 | 16.19 |
| Total | | 33.6 | 100.00 |

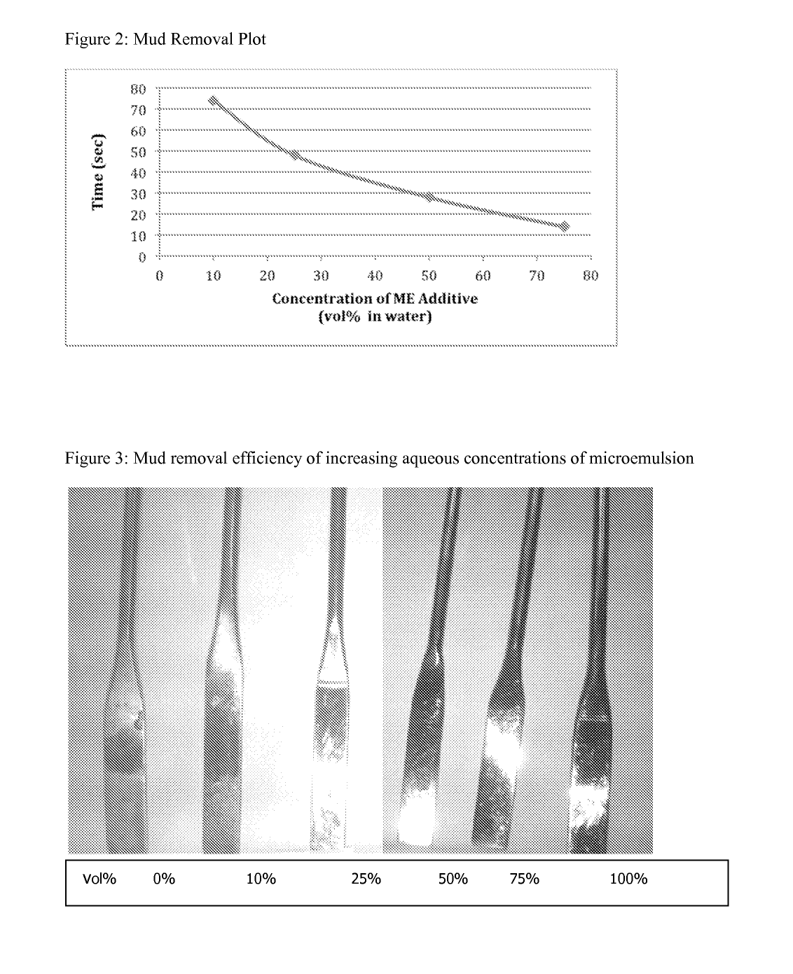

To evaluate the mud removal efficiency, a stainless steel spatula was immersed in a sample of synthetic oil-based mud. The spatula was removed and the excess oil was allowed to drip. The spatula was then immersed in the test solution and light gentle stirring was initiated. As shown in Table 2, the cleaning efficiency of the microemulsion in aqueous fluid is shown to increase as the concentration of microemulsion increases. No cleaning is observed in water alone. A plot of the data is provided in FIG. 2. As the concentration of the microemulsion additive in water increases, the time required for cleaning decreases. FIG. 3 provides a visual image showing the degree of mud removal for various concentrations of the microemulsion additive in aqueous solution.

TABLE 2
Performance Data Table

| | | | | | | |
|---|---|---|---|---|---|---|
| Fresh water | 100 | 90 | 75 | 50 | 25 | 0 |
| Microemulsion | 0 | 10 | 25 | 50 | 75 | 100 |
| Additive | | | | | | |
| Time (min:sec) | +2:00 | 1:14 | 0:48 | 0:28 | 0:14 | 0:14 |
| | Not | | | | | |
| | Clean | | | | | |
| Comment | One | One | Two | Three | Three | One |
| | Phase, | Phase, | Phases, | Phases, | Phases, | Phase, |
| | Clear | Milky | Milky | Clear | Clear | Clear |

The microemulsion may be used by itself or, as in the preferred embodiment, the microemulsion may be used with or followed by water or water-based fluid to change the water internal emulsion from oil-external to water external, resulting in a water-wet wellbore. It may also be added to a water-based fluid at a fixed concentration. Another method would be to pump the microemulsion with a stream of water and gradually increasing the concentration of the water in relation to the microemulsion to remove mud and gradually change the wellbore to a water-wet condition, as shown in Table 3.

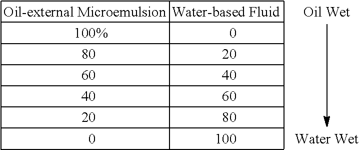

By way of example, the microemulsion in a concentration from 5% to 45% by total weight is combined with water or a water-based fluid in a concentration from 55%-95% by total weight to produce a spacer fluid according to the preferred embodiment. The microemulsion is combined with the water or water-based fluid to produce the spacer fluid either prior to exposing a surface such as a wellbore to the spacer fluid or, alternatively, a surface such as a wellbore may be exposed to the microemulsion followed by the exposure of the surface to the water or water-based fluid such that the resulting spacer fluid contacts the surface.

In a particular example of a well completion operation, a spacer fluid is created by the microemulsion in a concentration from 5% to 45% by total weight is combined with water or a water-based fluid in a concentration from 55%-95% by total weight. The spacer fluid is delivered into a wellbore such that the spacer fluid displaces a drilling fluid in the wellbore and contacts the wellbore to clean the wellbore and transition the wellbore from from oil-external to water external. After delivery of the spacer fluid, cement may be delivered into the wellbore in order to cement the casing and finish the well completion operation.

The microemulsion spacer fluid may be optionally, weighted and/or viscosifled to improve its displacement characteristics.

Although the present invention has been described in terms of the foregoing embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing description; rather, it is defined only by the claims that follow.

1. A microemulsion, comprising:
at least one emulsifying surfactant in a concentration from 0 to 40% by weight of the composition;
at least one biodegradable hydrocarbon solvent in a total concentration from 0 to 70% by weight of the composition;
at least one co-solvent in a concentration from 0 to 70% by weight of the composition;
at least one hydrocarbon co-surfactant in a concentration from 0 to 60% by weight of the composition; and
water in a concentration of 0 to 60% by weight of the composition.

2. The composition of claim 1, wherein the emulsifying surfactants are selected from the group consisting of polyoxyethylene sorbitan (20) monooleate and polyoxyetheylene sorbitan (20) monolaurate.

3. The composition of claim 1, wherein the biodegradable hydrocarbon solvents are selected from the group consisting of methyl caprylate, methyl caprate, methyl laurate, methyl myristate, methyl palmitate, methyl oleate, canola methyl ester, soya methyl ester and ethyl lactate.

4. The composition of claim 1, wherein the co-solvents are selected from the group consisting of alcohols, glycol ethers and mutual solvents.

5. The composition of claim 1, wherein the hydrocarbon co-surfactant are selected from the group consisting of cationic, anionic, amphoteric and nonionic surfactants.

6. The composition of claim 1, wherein water may be comprised of fresh water, salt water or brine.

7. The composition of claim 1, wherein:
the preferred emulsifying surfactants are sorbitan monoleate ethoxylate, polyoxyethylene 20, 1.79% by weight of the composition, and linear alcohol ethoxylate, 5.95% by weight of the composition;
the preferred biodegradable hydrocarbon solvent is methyl caprylate/caprate at 47.62% by weight of the composition;
the preferred co-solvent is Clariant Surftreat 9294, (CAS proprietary), 23.81% by weight of the composition;
the preferred hydrocarbon co-surfactant is 26% aqueous solution Sodium Lauryl Sulfate, 17.86% by weight of the composition; and
water, 16.19% by weight of the composition.

8. A spacer fluid, comprising:
microemulsion in a concentration from 5 to 45% by weight of the spacer fluid; and
water or a water based fluid in a concentration from 55 to 95% by weight of the spacer fluid.

9. The spacer fluid of claim 8, wherein the microemulsion, comprises:
at least one emulsifying surfactant in a concentration from 0 to 40% by weight of the composition;
at least one biodegradable hydrocarbon solvent in a total concentration from 0 to 70% by weight of the composition;
at least one co-solvent in a concentration from 0 to 70% by weight of the composition;
at least one hydrocarbon co-surfactant in a concentration from 0 to 60% by weight of the composition; and
water in a concentration of 0 to 60% by weight of the composition.

10. The composition of claim 9, wherein the emulsifying surfactants are selected from the group consisting of polyoxyethylene sorbitan (20) monooleate and polyoxyetheylene sorbitan (20) monolaurate.

11. The composition of claim 9, wherein the biodegradable hydrocarbon solvents are selected from the group consisting of methyl caprylate, methyl caprate, methyl laurate, methyl myristate, methyl palmitate, methyl oleate, canola methyl ester, soya methyl ester and ethyl lactate.

12. The composition of claim 9, wherein the co-solvents are selected from the group consisting of alcohols, glycol ethers and mutual solvents.

13. The composition of claim 9, wherein the hydrocarbon co-surfactant are selected from the group consisting of cationic, anionic, amphoteric and nonionic surfactants.

14. The composition of claim 9, wherein water may be comprised of fresh water, salt water or brine.

15. The composition of claim 9, wherein:
the preferred emulsifying surfactants are sorbitan monooleate ethoxylate, polyoxyethylene 20, 1.79% by weight of the composition, and a linear alcohol ethoxylate, 5.95% by weight of the composition;
the preferred biodegradable hydrocarbon solvent is methyl caprylate/caprate at 47.62% by weight of the composition;
the preferred co-solvent is Clariant Surftreat 9294, (CAS proprietary), 23.81% by weight of the composition;
the preferred hydrocarbon co-surfactant is 26% aqueous solution Sodium Lauryl Sulfate, 17.85714% by weight of the composition; and
water, 16.19% by weight of the composition.

16. A method of converting a microemulsion to a spacer fluid, comprising:
preparing a microemulsion; and
combining the mircoemulsion in a concentration from 5 to 45% by weight with water or a water based fluid in a concentration from 55 to 95% by weight, thereby producing the spacer fluid.

17. The method of converting a microemulsion to a spacer fluid of claim 16, wherein preparing the micro emulsion, comprises:
providing at least one emulsifying surfactant in a concentration from 0 to 40% by weight of the composition;
providing at least one biodegradable hydrocarbon solvent in a total concentration from 0 to 70% by weight of the composition;
providing at least co-solvent in a concentration from 0 to 70% by weight of the composition;
providing at least one hydrocarbon co-surfactant in a concentration from 0 to 60% by weight of the composition;
providing water in a concentration of 0 to 60% by weight of the composition; and
combining the at least one emulsifying surfactant, the at least one biodegradable hydrocarbon solvent, the at least co-solvent, the at least one hydrocarbon co-surfactant, and the water, thereby producing the microemulsion.

18. The method of converting a microemulsion to a spacer fluid of claim 17, wherein the emulsifying surfactants are selected from the group consisting of polyoxyethylene sorbitan (20) monooleate and polyoxyetheylene sorbitan (20) monolaurate.

19. The method of converting a microemulsion to a spacer fluid of claim 17, wherein the biodegradable hydrocarbon solvents are selected from the group consisting of methyl caprylate, methyl caprate, methyl laurate, methyl myristate, methyl palmitate, methyl oleate, canola methyl ester, soya methyl ester and ethyl lactate.

20. The method of converting a microemulsion to a spacer fluid of claim 17, wherein the co-solvents are selected from the group consisting of alcohols, glycol ethers and mutual solvents.

21. The method of converting a microemulsion to a spacer fluid of claim 17, wherein the hydrocarbon co-surfactants are selected from the group consisting of cationic, anionic, amphoteric and nonionic surfactants.

22. The method of converting a microemulsion to a spacer fluid of claim 17, wherein water may be comprised of fresh water, salt water or brine.

23. The method of converting a microemulsion to a spacer fluid of claim 17, wherein:
the preferred emulsifying surfactants are sorbitan monooleate ethoxylate, polyoxyethylene 20, 1.79% by weight of the composition, and a linear alcohol ethoxylate, 5.95% by weight of the composition;
the preferred biodegradable hydrocarbon solvent is methyl caprylate/caprate at 47.62% by weight of the composition;
the preferred co-solvent is Clariant Surftreat 9294, (CAS proprietary), 23.81% by weight of the composition;
the preferred hydrocarbon co-surfactant is 26% aqueous solution Sodium Lauryl Sulfate, 17.86% by weight of the composition; and
water, 16.19% by weight of the composition.

24. A method of cleaning a surface, comprising:
preparing a microemulsion;
combining the mircoemulsion in a concentration from 5 to 45% by weight with water or a water based fluid in a concentration from 55 to 95% to produce a spacer fluid; and
contacting the surface with the spacer fluid.

25. The method of cleaning a surface of claim 24, wherein contacting the surface with the spacer fluid transitions fluid on the surface from oil-external to water external.

26. The method of cleaning a surface of claim 24, wherein preparing the microemulsion, comprises:
providing at least one emulsifying surfactant in a concentration from 0 to 40% by weight of the composition;
providing at least one biodegradable hydrocarbon solvent in a total concentration from 0 to 70% by weight of the composition;
providing at least co-solvent in a concentration from 0 to 70% by weight of the composition;
providing at least one hydrocarbon co-surfactant in a concentration from 0 to 60% by weight of the composition;
providing water in a concentration of 0 to 60% by weight of the composition; and
combining the at least one emulsifying surfactant, the at least one biodegradable hydrocarbon solvent, the at least co-solvent, the at least one hydrocarbon co-surfactant, and the water, thereby producing the microemulsion.

27. The method of cleaning a surface of claim 26, wherein the emulsifying surfactants are selected from the group consisting of polyoxyethylene sorbitan (20) monooleate and polyoxyetheylene sorbitan (20) monolaurate.

28. The method of cleaning a surface of claim 26, wherein the biodegradable hydrocarbon solvents are selected from the group consisting of methyl caprylate, methyl caprate, methyl laurate, methyl myristate, methyl palmitate, methyl oleate, canola methyl ester, soya methyl ester and ethyl lactate.

29. The method of cleaning a surface of claim 26, wherein the co-solvents are selected from the group consisting of alcohols, glycol ethers and mutual solvents.

30. The method of cleaning a surface of claim 26, wherein the hydrocarbon co-surfactant are selected from the group consisting of cationic, anionic, amphoteric and nonionic surfactants.

31. The method of cleaning a surface of claim 26, wherein water may be comprised of fresh water, salt water or brine.

32. The method of cleaning a surface of claim 26, wherein:
the preferred emulsifying surfactants are sorbitan monooleate ethoxylate, polyoxyethylene 20, 1.79% by weight of the composition, and alinear alcohol ethoxylate, 5.95% by weight of the composition;
the preferred biodegradable hydrocarbon solvent is methyl caprylate/caprate at 47.62% by weight of the composition;
the preferred co-solvent is Clariant Surftreat 9294, (CAS proprietary), 23.81% by weight of the composition;
the preferred hydrocarbon co-surfactant is 26% aqueous solution Sodium Lauryl Sulfate, 17.86% by weight of the composition; and
water, 16.19% by weight of the composition.
